(19) United States
(12) Patent Application Publication
(10) Pub. No.: US 2006/0089053 A1
(43) Pub. Date: Apr. 27, 2006

(54) Connector system for connecting a first part and a second part, connector assembly and device board

(75) Inventors: Danny Louis Cornelius Morlion, Gent (BE); Stefaan Hendrik Josef Sercu, Branchaat (BE)

Correspondence Address: HARRINGTON & SMITH, LLP, 4 RESEARCH DRIVE, SHELTON, CT, 06484-6212, US

(73) Assignee: FCI, Versailles (FR)

(21) Appl. No.: 10/523,903

(22) PCT Filed: Jul. 22, 2003
(86) PCT No.: PCT/EP03/50327

§ 371 Date: Aug. 19, 2005

(30) Foreign Application Priority Data
Aug. 5, 2002 (NL) 1021208

(51) Int. Cl. H01R 24/00

(52) U.S. Cl. 439/660

(57) ABSTRACT

The invention relates to a system for connecting a first part and a second part, wherein the first part comprises a power supply line, a plurality of signal contacts and a plurality of ground contacts and the second part comprises a plurality of corresponding signal contacts and a plurality of corresponding ground contacts. The power supply line is connected via at least one ground contact of said first part to a corresponding ground contact of said second part. The first part may be a device board and said second part may be a connector assembly. The invention further relates to a cable connector for use in such a system.

The invention relates to a connector system for a first part and a second part, wherein:
said first part comprises a power supply line, a plurality of signal contacts and a plurality of ground contacts
said second part comprises a plurality of corresponding signal contacts and a plurality of corresponding ground contacts

It is well known that signals that are transmitted over a cable will degrade with regard to their initial characteristics. This degradation may depend on several factors, such as the length of the cable over which the signals are transmitted or the frequency of the signals being transmitted.

To account for this degradation behaviour, signals are manipulated to improve the overall quality of the transmitted signal. In a simple approach, manipulation of the signals is achieved by using passive compensation. In this approach electronic circuits comprising passive components such as resistots, capacitors and inductors are used. These passive components may be applied on e.g. a device board or printed circuit board (PCB's). Alternatively, the passive components can be applied in a connector assembly at the side intended to mate with the device board for transmitting the signals.

However, in many circumstances passive compensation is inadequate to maintain the quality of the transmitted signals at the required level. This may e.g. be the case if the length of the cable that transmits the signals exceeds a certain limit. In such a case, active compensation is required. Active compensation is a known technique for manipulating signals. Electronic circuits, performing active compensation tasks, are conventionally applied at the device board. The power for such an electronic circuit for performing these compensation tasks is acquired from a power source on the device board.

Since it is not known beforehand what type of cable, with respect to e.g. the cable length, is going to be connected to the device board, the prior art approach is to apply an active compensation circuit on'the device board to allow any connection of any type of cable. This approach is rather inefficient and expensive.

It is an object of the invention to provide a solution for these and other problems of the prior art.

This object is achieved by providing a connector system for a first part and a second part, characterised in that said power supply line is connected to at least one ground contact of said first part and extended into said second part by a connection between said ground contact and a corresponding ground contact of said second part. By implementing the electronic circuit for active compensation in the second part (e.g. a connector assembly), the first part (e.g. the device board) may be designed without the active compensation circuit. Only when active compensation is actually required, an electronic circuit for performing active compensation tasks has to be applied in the second part. The electronic circuit in the second part is powered via the power supply line from the first part via suitable ground contacts of the first and second part. The invention thus involves a more efficient and less expensive approach with regard to signal manipulation. The cable assembly may comprise also electronic circuits that manipulate or process the signal on transmitting or receiving such a signal.

In an embodiment of the invention the first part is a PCB or device board and the second part is a connector assembly for transmitting signals over a cable to a third part. This third part may be another PCB or device board. The cable assembly may comprise electronic circuits powered according to the invention on both sides.

In an embodiment of the invention the connector assembly is adapted to isolate said power supply line from said cable. This ensures that, while a voltage is applied to the electronic circuit in the cable connector, the cable does not transmit the voltages further as to avoid dangerous situations or conflicts with regulatory requirements.

The invention also relates to a connector assembly for use in such as system. The connector assembly comprising an electronic circuit is adapted as to receive a voltage from a power supply line in the first part via a suitable ground pin. The arrangement is such that this voltage is not carried further in the cable to a third part.

The invention also relates to a device board for use in a connector system. At least one of the ground pins of such a device board or connector thereof is dedicated to be fed by a power supply line as to provide power to a cable connector or assembly.

U.S. Pat. No. 5,037,313 discloses an active plug-in part comprising an electronic circuit in a cable connector. The publication however does not disclose how the electronic circuit is powered.

The embodiments of the invention will be described into more detail below with reference to the attached drawing of which

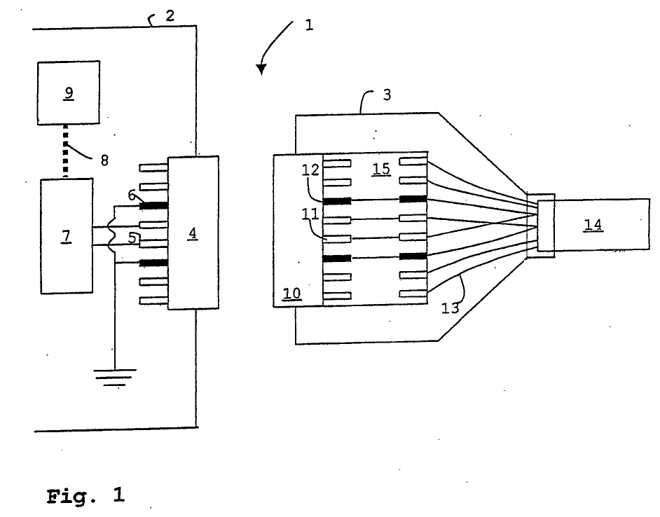

FIG. 1 schematically illustrates a connector system for a device board and a connector assembly according to the prior art;

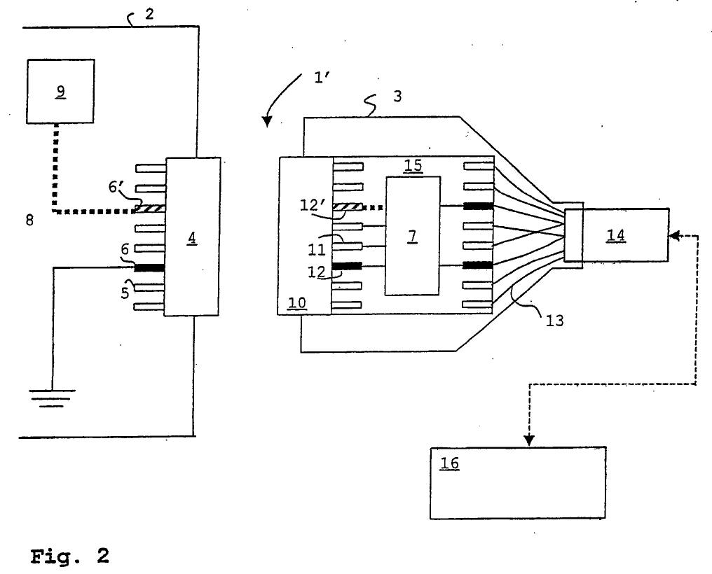

FIG. 2 schematically illustrates a connector system for a device board and a connector assembly comprising an electronic circuit according to an embodiment of the invention.

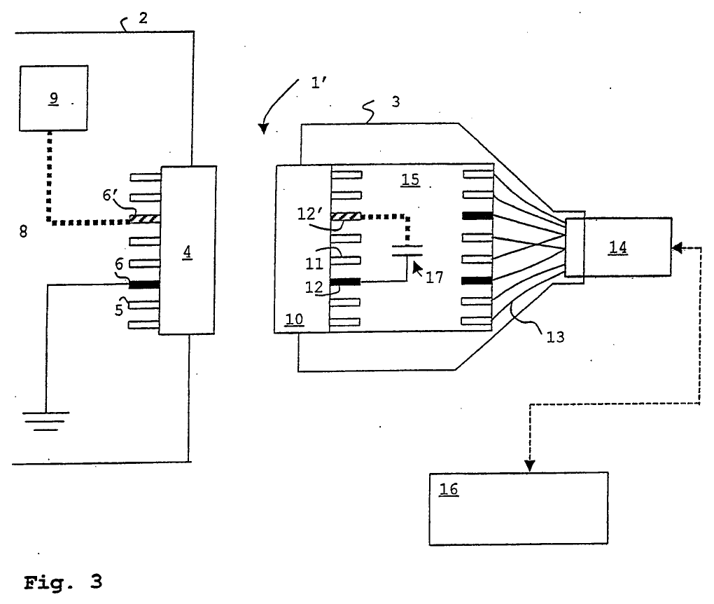

FIG. 3 schematically illustrates a connector system for a device board and a connector assembly without an electronic circuit according to an embodiment of the invention.

In FIG. 1 a system 1 for connecting a first part 2 and a second part 3 is shown according to the prior art. The first part 2 will hereinafter be referred to as device board 2. The second part 3 will hereinafter be referred to as connector assembly 3. Device board 2 comprises a connector 4* comprising signal contacts 5 and ground contacts 6. The signals from the device board 2 can be manipulated by the electronic circuit 7. This electronic circuit 7 performs active compensation tasks for signals to be transmitted through the connector assembly 3. The electronic circuit 7 is powered over the power supply line 8, indicated by the thick dashed line, by the voltage source 9 present at the device board side. It is noted that the voltage source 9 is not necessarily an integral part of the device board 2.

The connector assembly 3 comprises a connector 10 comprising signal contacts 11 corresponding to the signal contacts 5 of the device board 2 and ground contacts 12 corresponding to the ground contacts 6 of the device board 2. The contacts 11 and 12 are connected via wires 13 and are connected to the cable 14. In most cases a board or card 15 is provided to connect the contacts 11 and 12 with the wires 13 of the cable 14.

In FIG. 2 a system 1′ for connecting a first part 2 and a second part 3 according to an embodiment of the invention are shown. Parts of the system 1′ that are similar or identical to the parts displayed for the system 1 in FIG. 1 are indicated by the same reference numerals.

In the embodiment of the invention the electronic circuit 7 is part of the connector assembly 3, e.g. by accommodating the electronic circuit 7 on a board or card 15 mounted to or within the connector assembly 3 or cable connector 10. The electronic circuit 7 is powered from the voltage source 9 by assigning or dedicating at least one of the ground contacts 6 for connection to the power supply line 8. This contact 6′ of connector 4 of the device board 2 has a corresponding contact 12′ for extending the power supply line 8 into the connector assembly 3 as to apply the voltage to the electronic circuit 7. The voltage supply path 8 is indicated by the thick dashed line in FIG. 2. The other ground contacts 7 and corresponding ground contacts 13 remain to be used for grounding purposes. Moreover, FIG. 2 illustrates that the power supply line is isolated from the wires 13 of the cable 14 to avoid the wires 13 to carry a substantive voltage over the cable 14 to a third part 16.

In operation of the system 1′, the device board 2 and connector assembly 3 are connected to each other by connecting the connectors 4 and 10 such that the signal contacts 5 and 11 and the ground contacts 6 and 12 meet. In that case the contacts 6′ and 12′ also connect as a result of which the voltage source 9 is connected to the electronic circuit 7 via the power supply line 8 that extends into the connector assembly 2. Thus, the electronic circuit 8 is powered from the device board 2.

Since the electronic circuit 7 is powered, signals transmitted over the signal contacts 5 and 11 can be manipulated in order to optimise these signals and transmit them to e.g. the third device 16. The electronic circuit 8 may e.g. be an active equalisation device. Connector assemblies comprising such active compensation devices only have to be applied if e.g. the length of cable 14 exceeds a certain limit. It is noted that the electronic circuit may comprise passive components.

In FIG. 3 the situation is illustrated wherein the board 15 does not comprise an electronic circuit 7. However, the device board 2 still connects the power supply line 8 to the ground contact 6′ thereby extending the power supply line via the corresponding ground contact 12′ into the cable assembly 3. In such a case the cable assembly 3 for the cable 14 may still be used, since the board 15 of the cable assembly 3 may comprise e.g. a capacitor 17 grounded via the remaining ground contacts 12 and 6 at the ground of e.g. the device board 2. As an alternative the corresponding ground contact 12′ is isolated in the cable assembly 3.

For the purpose of teaching the invention, a preferred embodiment of the system for transmitting signals and a connector have been described above. It will be apparent for the person skilled in the art that other alternative and equivalent embodiments of the invention can be conceived and reduced to practice without departing from the true spirit of the invention.

1. Connector system for a first part and a second part, wherein:
said first part comprises a power supply line, a plurality of signal contacts and a plurality of ground contacts;
said second part comprises a plurality of corresponding signal contacts and a plurality of corresponding ground contacts
characterised in that
said power supply line is connected to at least one ground contact of said first part and extended into said second part by a connection between said ground contact and a corresponding ground contact of said second part.

2. Connector system according to claim 1, wherein said first part is a device board and said second part is a connector assembly of a cable for transmitting signals to a third part.

3. Connector system according to claim 2, wherein said connector assembly is adapted to isolate said power supply line from said cable.

4. Connector system according to claim 1 wherein said connector assembly comprises an electronic circuit fed, in operation, by said power supply line.

5. Connector system according to claim 4 wherein said electronic circuit comprises an active equalisation device.

6. Connector assembly for use in a connector system according to any of the preceding claims.

7. Device board for use in a connector system according to claim 1.
